(19) United States
(12) Patent Application Publication
(10) Pub. No.: US 2004/0168164 A1
(43) Pub. Date: Aug. 26, 2004

(54) Method and system for repair servicing of computers

(76) Inventor: Oleksiy Shevchenko, Kiev (UA)

Correspondence Address: John Becker, Suite 330, 980 Broadway, Thornwood, NY, 10594, US

(21) Appl. No.: 10/416,241

(22) PCT Filed: Jan. 16, 2001
(86) PCT No.: PCT/US01/00011

(30) Foreign Application Priority Data
Nov. 6, 2000 (UA) 2000116262

(51) Int. Cl. G06F 9/44

(52) U.S. Cl. 717/168; 717/103; 717/104

(57) ABSTRACT

A method for repair servicing of computers is based on the use of a regularly upgraded repair expert system (RES). It comprises a knowledge base an hardware and software, sources of failures and identifiers for those failures, diagnostics and repair scripts, and system for controlling databases. At least one fragment is decollated from the complete RES and stored on an isolated means for storage and output of information, said fragment, which is used for diagnostics and recovery of each failure, being sufficient for off-line restoration of computer up state in typical cases. The fragment necessarily comprises identifiers for failures and means for calling a Help Desk with the indication of only identifiers for those failures that haven't been recovered. A system for repair servicing comprises a Help Desk and at least one said decollated means for storage of the RES fragment.

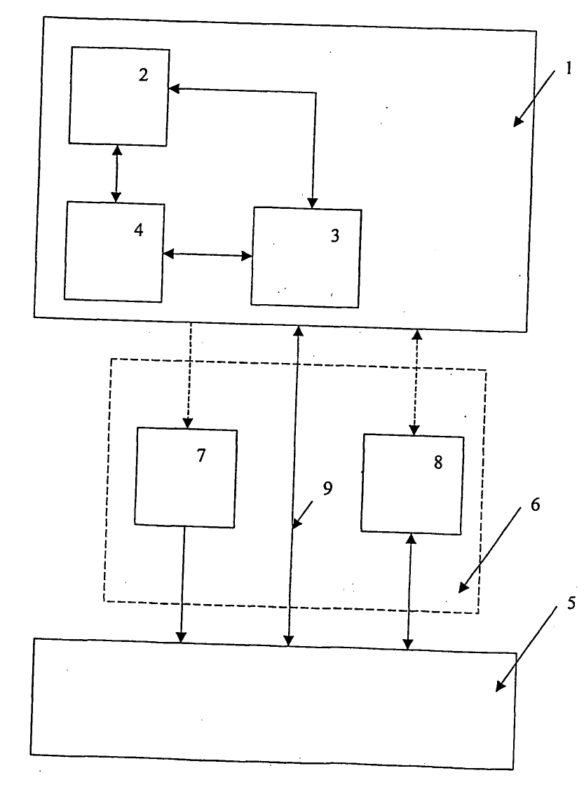

### FIELD OF INVENTION

The invention relates to repair servicing, particularly to a remote servicing preferably of personal computers (PCs hereafter), and more particularly to the diagnostics of hardware (HW hereafter) and software (SW hereafter) failures, and preferably SW repair.

The invention may be used under the conditions when the user's computer can be started at least with a help of a suitable repair medium with an appropriate SW, or with a help of an intermediate repair computer, or under the control of a remote Help Desk, provided that this Help Desk has been called up with the help of said repair medium or said repair computer, said Help Desk and the user's inoperative computer being interconnected by means of at least one communication channel.

For the purpose of this description, the following terms as employed herein and in the appended claims refer to the following concepts:

“User's (inoperative) computer” refers preferably to a PC characterized by at least one such failure of at least one HW and/or at least one SW which the user cannot detect and/or recover without assistance.

“Repair servicing” refers to:

first, automated diagnostics of at least one user's computer to detect defective HW units for their instant or posterior repair or posterior replacement and/or to detect defective SW portions;

second, automatic or “manual” repair of HW;

third, preferably automatic repair of SW; and

fourth, installation of mentioned below provisional “software stubs” on those hardware or software drivers that cannot be repaired with the help of a utilized fragment of a repair expert system or the complete repair expert system available because:

either the cause for such failure was not known to the repair expert system by the moment of the call,

or the repair expert system was unable to identify any hardware or software of the design being latest for the moment of the call.

“Off-line repair servicing” refers to at least a partial repair servicing of the user's inoperative computer without employment of a Help Desk “Repair expert system” (RES hereafter) refers to a program complex being systematically upgraded in an interactive mode with experts participation and comprising at least a HW knowledge base, a SW knowledge base, a knowledge base on scripts for diagnostics and repair of users' computers, a database on computer viruses and software resources for their recognition and elimination, and a system for controlling said knowledge bases and databases which includes at least one software for connecting a user's inoperative computer to the RES.

“Repair medium” (RM hereafter) refers to a hardware device which is always needed and frequently sufficient for off-line repair servicing of the user's computer with the use of at least one functionally isolated RES fragment stored on this medium.

“Standalone intermediate repair computer>> (SIRC hereafter) refers to such hardware which:

is intended for off-line repair servicing of users' computers either at their location (preferably in LAN) or at such distance from the location of the above mentioned computers that is generally substantially shorter than the distance to the nearest Help Desk, and

is equipped with at least one appropriate RM having at least one functionally isolated RES fragment stored thereon.

“Standard software” refers to operating systems (OS hereafter), such as Windows®, Unix® etc., and program complexes, such as Microsoft Office, Lotus Smart-suite etc.

“Standard programs for testing hardware up state” refer to a POST (Power On Self Test) type routine built into BIOS, or any other programs built into OS for testing standard units and common peripherals.

“Standard programs for testing software up state” refer to programs for testing specialized software, which are generally built into OS, or which are supplied to the users for extra fee by the companies that specialize in software production and installation.

“Help Desk” refers to a company having a complex of hardware and software including a complete RES, and expert personnel needed for remote repair servicing of any type of computers, for systematic improvement of the complete RES and for delivery of RES fragments for off-line repair servicing of users' computers. Therefore, this Help Desk, as employed herein, serves as a supplier of RM and/or SIRC equipped with functionally isolated RES fragments.

### PRIOR ART

It is well-known that:

nowadays computers and, especially, PCs are goods of mass production and use;

HW and SW failures on users' computers quite often result in serious economic losses, especially if at least two computers are connected in a local network to share their hardware and information resources;

Continuous development of SW, in particular of OSs with graphic interface, such as Windows®, Unix® etc., is notably ahead of common users potential for practical coping in full scope with all the opportunities provided to them by those more and more sophisticated OSs and applied program complexes;

the majority of common PC users do not know well the structure of the computer and peripheral HW, content and structure of SW and principles of programs interaction (especially in those cases when individual SW portions have been purchased from different producers and installed without proper consideration of their compatibility); and

such users (whose number, apropos, is being constantly increased) cannot restore the computer up state themselves in case of repeated failures in computer booting or executing some commands, and require off-site help.

The need in such off-site help became rather appreciable back in the period of the end of eighties to beginning of nineties of the 20^{th} century. At that time, sources for computer failures were systematized, and the first systems for their remote diagnostics were developed (see, for example: 1. Bondavalli et al., “Failure Classification with Respect to Detection”, Future Trends of Dist. Computing Sys., 1990, IEEE Pub. pp. 47-53; 2. Griffin, “A Fault Diagnosis Prototype for Ethernet LANs”, IEE Colloq. 1989, No. 64: Expert Systems for Fault Diagnosis in Engineering).

It has been determined that computer faults are usually caused by:

(1) physical failure in HW, among which the most common are defects in the boot disk or network equipment;

(2) code distortions in the boot sector of the start-up disk;

(3) file allocation table (FAT) corruption;

(4) malfunctions in BIOS execution (for example, BIOS program code corruption, absence or distortion of the BIOS configuration information stored in the computer CMOS memory);

(5) corruption in HW configuration information or applied SW;

(6) conflicts between individual HW or/and SW portions;

(7) OS or applied SW files corruption.

Nowadays it is obvious not only to experts, but also to common users that:

the majority of the mentioned sources of failure, in particular the sources (2, 3, 4, 5, 7 and quite often 6), often arise under the influence of computer viruses, which get into users' computers during the exchange of information with other users, in particular while using electronic mail and the INTERNET,

the latest computer viruses are the most dangerous ones, and the means for their elimination become accessible to the common users with delay, and

as the range of more and more sophisticated HW and SW extends, the total amount of failures causing common users to address to remote Help Desks (via modems or functionally similar digital devices and channels of communication, e.g. telephone lines) for assistance in failure recovery grows notably faster than the amount of sold computers.

Such remote repair servicing is especially convenient when a user's computer is located away from “civilization centers” where it is possible to eliminate the sources of detected HW and SW failures only on the basis of the results of the remote diagnostics with the support of competent assistance.

It is obvious that the RES and Help Desk experts are compelled to diagnose and recover those failures that actually happen while working with those users that actually exist. Therefore, the methods and means for repair servicing of users' computers that are remote from Help Desks should be designed so as to minimize:

the risk of misunderstanding between the users of inoperative computers (whose training is not included in the Help Desk responsibilities) on one side and RES and live experts of any such Help Desk on the other side;

traffic in data exchange via communication channels between the user's inoperative computer and the Help Desk whose service the user has subscribed; and

specific expenses of software, hardware and other means per case of repair servicing.

Combined complying with these conditions has appeared to be rather a complex problem, for the dialogue between a common user and the Help Desk is as less productive:

as more complicated is the cause of failure,

as less experienced is the user,

as busier is the communication channel between the user's computer and the selected Help Desk, and

as larger amounts of data should be transferred via the communication channel in both directions to diagnose and cure the users computer up state.

A method of remote repair servicing of users' computers is described, e.g., in the U.S. Pat. No. 5,367,667. This method includes:

calling a Help Desk expert by a phone call of the user who orally explains to the expert the arisen difficulties to the extent of his or her understanding of the problem and gives the information on the computer,

creating a script program on a Help Desk computer, said script program including a file identifier, information for identification of user's computer (to be diagnosed), information for remote access to the user's computer data, information for the user' computer remote access to the Help Desk computer data, and test (diagnostic) instructions;

setting the user's computer into an auto-answer communications mode;

establishing remote data communications between said Help Desk computer and said user's computer;

downloading said diagnostic script program from the Help Desk computer to the user's computer, said Help Desk computer terminating communications upon completion of download;

executing said test instructions by the user's computer in an unattended mode and creating log files of the execution of said test instructions;

transferring said log files of the execution from the user's computer to said Help Desk computer;

determining the needs of the user's computer in SW repair;

selecting software applications required for the repair; and

correcting defective portions of SW.

Such process,

firstly, doesn't provide for the restoration of HW up state, and

secondly, generally requires as much greater time consumption to explain the nature of the problem to the Help Desk expert, and as much busier a communication channel, as less experienced the user is, and as more complicated is the cause for the computer failure.

Therefore, the diagnostic script program created by the Help Desk computer, usually cannot provide for the restoration of the SW up state within one session of remote diagnostics and repair.

Moreover, in the cases when the PC failure is caused only by HW defects, an “extended” basic input/output control system (E-BIOS) in accordance with the U.S. Pat. No. 5,732,268 can be useful for remote debugging.

This E-BIOS (in fact, program) system includes:

a first code portion for providing power-on self-test and start-up functions for the user's computer, which includes a code for recognizing a case when said computer does not boot, and

a second code portion for establishing communication of the user's computer with a remote service computer in the event of failure to boot.

Further, a master code kernel of the service computer automatically downloads a slave kernel to random access memory of the user's computer and provides preferably in the automatic mode for: (1) access to the memory devices of the users computer, (2) correction of the codes and data stored in this computer, and (3) attempt to reboot the computer after such repair.

Exclusion of the user from data communications with a Help Desk expert provides for easier restoration of the used's computer up state. However:

system for recognition of failure sources built in E-BIOS actually traces only failure codes while executing the POST routine of the main BIOS of the user's computer;

accordingly, E-BIOS detects only such seldom happening critical failures, as hard disk or any other hardware device failures at the stage of the user's computer start-up, but does not detect the sources for those frequently happening cases of so-called “hang-up”, which can be caused by SW defects, and HW and/or SW conflicts;

a communication channel between the user's computer and a Help Desk is busy during all the session of remote diagnostics and repair because of the need to transfer a master code kernel and other necessary information; and finally,

enlargement of the BIOS software package can become the source of failures itself because of possible conflicts with the latest versions of OS with built-in graphic interface.

A system of SW repair servicing for the users' computers equipped with HW, such as network devices, provides for wider functional advantages. Such system, according to the U.S. Pat. No. 5,673,386, provides not only for detecting failures, but also for their classification by (1) a severity level, and (2) a source of the failure with subsequent generating failure messages considering said characteristics as well as transmitting such messages to a remote Help Desk via a communication channel available.

However, even in case of using such systems, the communication channel between the user's computer and the Help Desk would be busy during the whole session of remote diagnostics and repair, and in especially complex cases a direct dialogue between the user and the Help Desk expert is needed.

That is why the most promising for computer repair servicing appear to be methods and devices that incorporate RESs.

Method and system described in the U.S. Pat. No. 5,983,364, which belong to that number, are the most alike with this invention in technological essence.

This known method of computer repair servicing is based on utilization of RES comprising at least a database on HW, a database on SW, a database on diagnostics and repair scripts, and a system for controlling said databases, said system including at least one means for connecting said RES to the user's inoperative computer. This method generally includes the following steps:

a) detecting at least one computer failure which the computer user can not recover without assistance;

b) directly connecting the user's inoperative computer to the RES via a communication channel;

c) at least once inspecting the inoperative computer hardware and software using said RES, and detecting at least one hardware or software means whose damage has caused the failure;

d) recovering the detected failure of the hardware means or outputting recommendations to the user on how to recover the failure without assistance; and/or

e) recovering the detected failure of the software means and, if necessary;

f) possibly repeating steps (a), (b), (c), (d) and (e) up to success or suspension of the repair servicing.

Correspondingly, the system for carrying out the described method has a Help Desk comprising at least:

at least one unit of non-volatile memory (EDRAM) for a long-term storage of the complete RES;

an executive unit in electrical communication with at least one said unit of non-volatile memory (EDRAM) and equipped with at least one means intended for direct connection of inoperative users' computers to RES via a suitable communication channel; and

a unit for analysis and temporary storage of the results of repair servicing of the users' computers, which unit being in electrical communication with at least one said unit of non-volatile memory and said executive unit.

This method and this system are rather convenient in repair servicing of computers. Actually, an extensive RES provides for

considerable reduction in the need for a dialogue between the user of the inoperative computer and the Help Desk and, correspondingly, in risk of misunderstanding between them, and also considerable extension of potentialities in repair servicing.

However, each call to the Help Desk is accompanied by a continuous traffic of complete data on HW and SW failures and complete data on means for recovery of failures between the user's computer and the RES. Therefore, the time needed for repair servicing will be as much higher, as more complicated is the source for each individual failure and as greater number of failures is detected when the user addresses to the Help Desk.

Moreover, under the conditions of constantly growing traffic on communication channels, even a call to the Help Desk can turn into a long story. Considering the fact that the RES under consideration should be called at each failure that a user can not recover without assistance, each call of this kind additionally increases the traffic on communication channels and specific expenses of software, hardware and other means per case of repair servicing.

### BRIEF DESCRIPTION OF INVENTION

This invention is based on the problem of improving a repair expert system and methods of its utilization so as to create such method of computer repair servicing and such system for its realization that could:

minimize traffic in data exchange between users' inoperative computers and the Help Desk via communication channels and, correspondingly,

additionally decrease the specific expenses of software, hardware and other means per case of repair servicing.

This problem is solved in that in the method of computer repair servicing, which:

is based on the use of RES comprising at least a database on hardware, a database on software, a database on diagnostics and repair scripts, and system for controlling said databases, which system including at least one means for connecting said repair expert system to the user's inoperative computer, and

includes the following steps:

a) detecting at least one computer failure which the computer user can not recover without assistance;

b) connecting the user's computer to the RES;

c) at least once diagnosing the hardware and software being part of a user's computer using said RES, and detecting at least one hardware or software means whose damage has caused the failure;

d) recovering the detected hardware means failure or outputting recommendations to the user on how to recover the failure without assistance; and/or

e) recovering the detected failure of the software means; and, if necessary;

f) repeating steps (a), (b), (c), (d) and (e) up to success or suspension of the repair servicing

according to the invention

(1) a regularly upgraded RES is created and used for computer repair servicing which generally includes:

(1.1) a knowledge base on hardware existing by the time of the latest upgrade of said RES, that is:

a) data on classes, types, design, functional capabilities and support drivers of HW which are used in computers, and identifiers assigned to each HW,

b) data on the producers of existing HW, on the current availability of individual HW on the market and on possibilities for equivalent replacement of failed HW made by one producer with suitable HW of same type made by another producer and identifiers assigned to the producers of existing HW,

c) data on sources, kinds and assessments of HW failures and identifiers for such assessments with decollation of identifiers for critical failures without recovery of which the restoration of the users' computers up state is impossible, and identifiers for failures that can be neglected for a while,

d) a library of exercisers for testing HW up state, which includes at least standard exercisers, and

e) recommendation to users on replacement, repair or suspension of failed HW from use;

(1.2) a knowledge base on SW existing by the time of the latest upgrade of said repair expert system, that is:

a) data on kinds and functional capabilities of at least existing standard SW means and identifiers assigned to each of such means,

b) data on sources and kinds of SW failures and identifiers for failures of specific SW means with decollation of identifiers for critical failures without recovery of which the restoration of the users' computers up state is impossible, and identifiers for failures that can be neglected for a while, and

c) software needed for diagnostics and recovery of the corrupted software up state on the users' computers, which includes a library of exercisers for testing at least standard SW, at least one program for restoration of such SW and at least one program for preferably automatic call to a Help Desk from the user's computer with indication of the identifier for corrupted software;

(1.3) database on computer viruses and software for their recognition and elimination; and

(1.4) system for controlling said knowledge bases and said database being capable of operating in automatic or interactive modes, as desired;

(2) prior to application of the described RES for computer repair servicing, at least one functionally isolated fragment is decollated therein, which fragment includes at least one program for preferably automatic call to the Help Desk from the user's computer when detecting at least one such hardware or software failure which can not be recovered under off-line repair servicing only with the use of said RES fragment and without recovery of which the restoration of said computer up state is impossible, said program providing for transfer of only identifiers relating to each not-recovered failure to the Help Desk;

(3) said decollated RES fragment is loaded into a isolated storage-and-output device supplied to at least one such computer user who wants to subscribe for the services of the Help Desk; and

(4) after having detected at least one said failure, off-line repair servicing of the inoperative computer is carried out to the extent of the possibilities provided by said decollated RES fragment, and then

(5) either such service is stopped when said computer up state has been restored or it is connected to the Help Desk via the communication channel and the repair servicing is continued with the help of this Help Desk, which Is equipped with the complete RES.

This method makes it possible:

first, to provide for the major proportion of time needed for the repair servicing to be spent in the off-line mode,

second, to significantly reduce traffic in data exchange between the user of the inoperative computer and the Help Desk and, correspondingly to lower specific expenses of software, hardware and other means per case of the repair servicing.

Actually, only in rare cases the off-line repair servicing fails to recover the fault of any hardware and/or software on the inoperative computer of a user who has subscribed for services of the Help Desk and received said decollated RES fragment in use. If such special case happens, only a set of identifiers relating to the not-recovered failure is transferred to the Help Desk via a communication channel, the selection of said set of identifiers being independent of the user's knowledge and skills.

Therefore, the complete RES incorporated in the Help Desk and a live expert of this center, if necessary, will receive sufficient information on failures and will be able to restore the user's computer up state within a shorter period of time and at smaller load on inherent hardware and software than usually.

The first additional characteristic feature consists in that the decollated RES fragment comprises at least:

a) data on classes, types, design, functional capabilities and support drivers of the HW used in computers, and the identifiers assigned to each hardware device;

b) a library of standard exercisers for testing HW up state;

c) recommendations to the users on repair, replacement or suspension of failed HW from use;

d) data on types and functional capabilities of existing standard SW means and identifiers assigned to each of such means;

e) identifiers for failures of specific standard SW means with decollation of identifiers for critical failures without recovery of which the restoration of the users' computers up state is impossible, and identifiers for failures that can be neglected for a while; and

f) at least one exerciser for testing at least standard SW;

g) at least one program for restoration of standard SW; and

h) at least one program for preferably automatic call to the Help Desk from the user's computer when detecting at least one such hardware or software failure which can not be recovered under off-line repair servicing only with the use of said RES fragment and without recovery of which the restoration of said computer up state is impossible, said program providing for transfer of only identifiers relating to each not-recovered failure to the Help Desk.

The size of said RES fragments is so small that they can be stored even on standard floppy disks and efficiently delivered to any subscribers of the remote Help Desks by mail for off-line repair servicing of inoperative computers. As a matter of fact, even such RES fragments are sufficient for effective off-line repair servicing of typical hardware and/or software failures.

The second additional characteristic feature consists in that the decollated RES fragment comprises at least:

(1) a portion of the knowledge base on hardware, that Is at least:

a) data on classes, types, design, functional capabilities and support drivers of HW which are used in computers, and identifiers assigned to'each HW;

b) data on sources, kinds and assessment of HW failures and identifiers for such assessments with decollation of identifiers for critical failures without recovery of which the restoration of the users' computers up state is impossible, and identifiers for failures that can be neglected for a while;

c) a library of standard exercisers for testing HW up state; and

d) recommendations to users on repair, replacement or suspension of failed HW from use;

(2) a portion of the knowledge base on the existing software, that is at least:

a) data on kinds and functional capabilities of existing standard SW means and identifiers assigned to each of such means,

b) data on sources and kinds of SW failures and identifiers for failures of specific SW means with decollation of identifiers for critical failures without recovery of which the restoration of the users' computers up state is impossible, and identifiers for failures that can be neglected for a while;

c) software needed for diagnostics and recovery of the corrupted standard software up state on the users' computers, which includes a library of exercisers for testing SW, at least one program for restoration of this SW and at least one program for preferably automatic call to the Help Desk from the users computer with indication of the identifier for corrupted software;

(3) database on computer viruses and software for their recognition and elimination; and

(4) system for controlling said portions of knowledge bases and said database, which can operate in automatic or interactive modes, as desired;

(5) at least one program for preferably automatic call to a Help Desk from the user's computer when detecting at least one such hardware or software failure which can not be recovered under off-line repair servicing only with the use of said RES fragment and without recovery of which the restoration of said computer up state is impossible, said program providing for transfer of only identifiers relating to each not-recovered failure to the Help Desk.

Such substantially more extended RES fragment allows significant expansion of possibilities of off-line repair servicing of the users' inoperative computers being distant from a Help Desk. This fragment can be supplied to users as stored on CAROM disks, which have greater capacity then floppies, flash memory microcircuits, or on portable disk drives with hard magnetic disks. However the most preferable solution is to provide such RES fragments:

(1) incorporated into repair mini-computers designed as attachment to individual computers in local computer networks, or

(2) incorporated into intermediate service computers, which can be installed by one in a group of local computer networks located close to each other.

The third additional characteristic feature consists in that software stubs are included in the complete RES and in at least one functionally isolated fragment decollated therefrom, which stubs are intended to mark hardware or software failures not specified by said system or the decollated fragment, such stubs being noted in each report on diagnostics and repair of each inoperative computer for the subsequent analysis and recovery of failures. This makes it possible:

first, to overcome limitations of diagnostic and repair capabilities of the smallest RES fragments as compared to the intermediate fragments; and of the intermediate fragments as compared to the complete RES, and

second, to detect such kinds of hardware or software failures, the diagnostics and recovery of which were not specified by the complete RES by the date of its latest upgrade, so that said system could be regularly improved with participation of live experts.

The above-mentioned problem is solved also in that the system for computer repair servicing is provided with a Help Desk comprising:

at least one unit of non-volatile memory for a long-term storage of the complete RES;

an executive unit electrically connected to said at least one unit of non-volatile memory and equipped with at least one means for connecting users' computers to RES, and

a unit for storage of structured (on the basis of types of failures) software for diagnostics and repair servicing of users' computers, said unit being electrically connected to said unit of non-volatile memory and said executive unit,

according to the invention

a) the system additionally comprises at least one isolated means for storage and output of information;

b) this means comprises a record of at least one RES fragment adapted for off-line repair servicing of inoperative computers prior to calling to a Help Desk, and calling to the Help Desk only in case of detecting such failure that cannot be recovered with the help of said fragment;

c) this means is supplied to at least one such computer user who wishes to subscribe for services of the Help Desk.

As it was mentioned in the comments on the brief description of the method, the decollation of functionally isolated RES fragments and their delivery to users for off-line repair servicing of computers located distantly from a Help Desk, makes it possible to considerably reduce traffic in the data exchange between the Help Desk and inoperative computers and to lower specific expenses on repair servicing.

The first additional characteristic feature consists in that such means for storage and output of information is preferably in the form of a changeable repair medium which, according to the second additional characteristic feature, is selected from the group consisting of the standard floppy disk, ZIP disk, CD-ROM disk, flash memory microcircuit and portable disk drive with a hard magnetic disk.

The second additional characteristic feature consists in that said isolated means for storage and output of information is in the form of a standalone intermediate repair computer, which has at least one inherent unit of non-volatile long-term memory, inherent executive unit, inherent unit for the analysis and storage of the results of repair servicing of users' computers, which unit is electrically connected to at least one said unit of non-volatile memory and said executive unit, and an optional inherent means for connection to communication channels, said intermediate computer being located between the Help Desk and distant users' computers;

a) according to the third additional characteristic feature, it is in the form of a minicomputer electrically connected to at least one user' computer, or

b) according to the fourth additional characteristic feature, it is in the form of an intermediate service computer located between the Help Desk and a group of users' computers situated close to each other.

The specific advantages of such characteristic features will be more apparent from the detailed description of this system given below.

It will be obvious to those skilled in the art that in choosing particular embodiments of the invention, random combinations of the mentioned additional characteristic features with the main inventive concept are possible, and that the preferred embodiments described herein are in no way limiting the scope of the invention.

### BRIEF DESCRIPTION OF THE DRAWING

The invention will now be explained by detailed description of a system and method for repair servicing of computers with reference to the accompanying drawing, wherein a block diagram of said system is represented.

### BEST MODE FOR CARRYING OUT THE INVENTION

Referring to the drawing, a system for computer repair servicing in any of the embodiments of the invention has a Help Desk 1, comprising:

at least one unit 2 of non-volatile memory for a long-term storage of a regularly upgraded complete RES;

an executive unit 3 electrically connected to at least one said unit 2 of non-volatile memory, and

a unit 4 for analyses and storage of results of repair servicing of users' computers 5, which unit being electrically connected to said at least one unit 2 of non-volatile memory and said executive unit 3.

The executive unit 3 is equipped with at least one means 6 for connecting a RES to the users' inoperative computers 5, which unit includes at least one of the following means, namely:

a) a preferably changeable repair medium 7 (RM 7), e.g., such as a standard floppy disk, or ZIP disk, or CD-ROM disk, or FLASH type memory microcircuit, or portable disk drive with a hard magnetic disk, and/or

b) a standalone intermediate repair computer 8 (SIRC 8) located between the Help Desk 1 and users' computers 5 being distant from this Help Desk, said repair computer 8 having the following components not shown in the drawing:

at least one inherent unit of non-volatile long-term memory for storage of at least one RES fragment for off-line repair servicing of the users' computers,

an inherent executive unit,

an inherent unit for analysis and storage of results of repair servicing of the users' computers 5, which is electrically connected to at least one said unit of non-volatile memory and said executive unit and, optionally,

an inherent means for connection to communication channels 9, and/or

an above mentioned communication channel 9 (e.g., telephone).

Said SIRC 8 can be made in the form of:

a) a minicomputer electrically connected to at least one user's computer 5 (and, particularly, built in such computer 5), or

b) an intermediate service computer located between the Help Desk 1 and a group of computers 5 situated in the same site.

RM 7 and SIRC 8 are used as means for loading, storage and output (use) outside of the Help Desk 1 of at least one functionally isolated RES fragment adapted for off-line repair servicing of any distant computer 5 in each case when its user detects at least one hardware and/or software failure which he or she cannot recover without assistance.

RM 7 can provide for off-line repair servicing of an inoperative computer 5 when the latter has retained the serviceability of an inherent central processor and at least of one suitable disk drives or ports, and

SIRC 8 can be used even in case of failure of the central processor of any computer 5 and/or means for its connection to the communication channel 9.

The RM 7 and/or SIRC 8 can be supplied to those users of distant computers 5 who subscribed for services of the Help Desk 1.

The Help Desk 1 can be connected to computers 5 via communication channels 9 either directly or via SIRC 8 with the help of modems (not shown in the drawing) or functionally similar devices, such as digital DSL- or ISDN-adapters built into such computers 5 and computers 8.

Repair servicing of computers 5 with the help of SIRC 8 can be carried out irrespectively of servicing with the help of RM7. However, it is preferable that the users who detect at least one failure which they cannot recover themselves would first use consecutively said RM7 and only then, said SIRC 8.

The concept of the repair servicing of computers located distantly from the Help Desk 1 will become more apparent from the description of the method of the invention.

In the most general embodiment, this method provides for

first, creating and using at a Help Desk 1 a complete RES being regularly upgraded in an interactive mode with the participation of live experts;

second, decollating in such RES at least one functionally isolated fragment sufficient for off-line repair servicing, i.e.:

for diagnostics of failure of at least standard hardware and software for recovery of at least such failures of hardware which have been caused by damage of HW support drivers, corruption of HW configuration information and conflicts between individual potions of HW, and

for recovery of failures of at least standard software, each failure in said RES fragment having its own identifier intended to be transferred to the Help Desk 1 in case the detected failure can not be recovered in the off-line repair servicing;

third, storing at least one of such RES fragments (usually on the choice of the user of any of the computers 5) on a suitable RM 7 and/or on the unit of non-volatile long-term memory SIRC 8,

fourth, providing such RES fragments to those users of distant computers 5 who would like to subscribe for the services of the Help Desk 1 being in possession of a complete RES;

fifth, using first at least one such RES fragment for off-line repair servicing of that inoperative computer 5 whose user will detect at least one such hardware and/or of software failure which the user is unable to recover without assistance, and

sixth, calling the Help Desk 1 only after it becomes obvious that it is impossible to recover at least one of the detected failures with the help of at least one functionally isolated RES fragment, only the identifiers related to each not-recovered failure being received by the Help Desk 1.

Said complete RES includes at least:

(1) a knowledge base on hardware existing by the date of the latest upgrade of said repair expert system, that is:

a) data on classes, types, design, functional capabilities and support drivers of HW used in computers 5, and identifiers assigned to each HW,

b) data on the producers of existing HW, on the current availability of individual HW at the market and on possibilities of equivalent replacement of failed HW of one producer by suitable HW of another producer, and identifiers assigned to producers of existing HW,

c) data on sources, kinds and assessments of HW failures and identifiers for such assessments with decollation of identifiers for critical failures without recovery of which the restoration of up state of the users' computers 5 is impossible, and identifiers for failures that can be neglected for a while,

d) a library of exercisers for testing HW up state, which includes at least standard exercisers, and

e) recommendation to users on replacement, repair or suspension of failed HW from use;

(2) knowledge base on the software existing by the date of the latest upgrade of said RES, that is:

a) data on kinds and functional capabilities of at least standard existing SW means and identifiers assigned to each of such means,

b) data on sources and kinds of SW failures and identifiers for failures of specific SW means with decollation of identifiers for critical failures without recovery of which the restoration of the users' computers up state is impossible, and identifiers for failures that can be neglected for a while, and

c) software needed for diagnostics and recovery of the corrupted software up state on the computers 5, which includes a library of exercisers for testing at least standard SW, at least one program for restoration of the SW and at least one program for preferably automatic call to the Help Desk from the user's computer 5 with Indication of the identifier for corrupted software;

(3) database on computer viruses and software for their recognition and elimination; and

(4) system for controlling said knowledge bases and said database being capable of operating in automatic or interactive modes, as desired.

Further, at least one functionally isolated fragment is decollated in the described RES and used for off-line repair servicing of the inoperative computers 5. This fragment comprises at least:

a) data on classes, types, design, functional capabilities and support drivers of the HW used in computers 5, and the Identifiers assigned to each hardware device;

b) a library of standard exercisers for testing HW up state;

c) recommendations to users on repair, replacement or suspension of failed HW from use;

d) data on types and functional capabilities of existing standard SW means and identifiers assigned to each of such means;

e) identifiers for failures of specific standard SW means with decollation of identifiers for critical failures without recovery of which the restoration of the users' computers 5 up state is impossible, and identifiers for failures that can be neglected for a while;

f) at least one exerciser for testing standard SW;

g) at least one program for restoration of standard SW; and

h) at least one program for preferably automatic call to SIRC 8 or the Help Desk 1 from the computer 5 when detecting at least one such hardware or software failure without recovery of which the restoration of said computer 5 up state is impossible, said program providing for transfer to SIRC 8 or the Help Desk 1 of the only identifier of each damaged hardware or software means which can not be repaired or recovered with the help of the utilized RES fragment.

Generally at least one RM 7 is required to store and deliver said minimum-size RES fragment at least to one computer 5 user who wishes to subscribe for the services of the Help Desk 1, and to use this fragment in the future. It should be noted that nowadays the RM 7 in the form of a floppy disk is the most preferable for loading, storage and off-line repair servicing of computers 5 with the help of the described minimum-size RES fragment because:

first, all existing nowadays computers 5 have at least one disk drive for such disks,

second, such disk drives are substantially insensitive to failures of the basic systems of the computers 5, that is why when it is impossible to start some of the computers 5 under the control of the inherent hard disk and/or a disk of CD-ROM type, it is usually possible to start it with the help of a floppy disk, and,

third, in most cases even one floppy disk is big enough to store such a minimum-size RES fragment which can restore serviceability of the computer 5 in cases of the most frequent failures, except for HW failures, such as physical damage of a boot disk or network equipment. However, even in this case the minimum-size RES fragment can prompt the user to the actions for failure restoration.

Having detected at least one failure which a user is unable to recover without assistance, said RM 7 is loaded in the appropriate disk drive of an inoperative computer 5 in its location. Then the computer 5 gets restarted in order to be serviced to the extent of the capacities provided by the RES fragment.

Such repair servicing includes:

a) at least once inspecting HW and SW incorporated in the inoperative computer 5 with the help of the minimum-size RES fragment and detecting at least one hardware or software means whose corruption caused the failure,

b) recovering the detected hardware failure or issuing recommendations to the user on how to recover the failure, and/or

c) recovering the detected software failure, and, if necessary,

d) possibly repeating steps (a) and/or (b), and/or (c) with the same or different RM 7 up to success or up to the admission of the fact that it is impossible to complete the repair with the use of the selected minimum-size RES fragment.

In the latter case, the minimum-size RES fragment connects the computer 5, immediately or after a “discussion” of the testing and repair results with the user, to:

either the nearest SIRC 8 to continue the repair servicing with the help of a larger RES fragment,

or the Help Desk 1 via the communication channel 9 and unit 4 for analyses and storage of the results of repair servicing of computers 5 and executive unit 3 belonging by this Help Desk 1 to continue the repair servicing with the help of the complete RES which is stored in the unit 2 of non-volatile memory.

It is apparent from the above description of the off-line repair servicing that:

only information on the combined identifiers relating to the failure which has not been recovered with the help of that (minimum-size) RES fragment which was stored on RM 7 is received at the SIRC 8 or Help Desk 1, and

the repair servicing at the level of the SIRC 8 or Help Desk 1 also assumes the operation up to the positive result or up to suspension of the current communication session with the inoperative computer 5 so as to update the RES with participation of live experts.

More advanced method of the off-line repair servicing of computers 5 includes decollating at least one larger and functionally isolated fragment 8 (hereafter determined as “intermediate fragment” for convenience) from the RES of the Help Desk 1 and installing it into at least one SIRC 8, said intermediate fragment further comprising:

(1) a portion of the knowledge base on HW, that is at least:

a) data on classes, types, design, functional capabilities and support drivers of HW used in the computers 5, and the identifiers assigned to each of the HW,

b) data on the sources, kinds and assessments of HW failures and identifiers for such assessments with decollation of (1) the identifiers for critical failures without recovery of which the restoration of the up state of computers 5 is impossible, and (2) the identifiers for failures which can be neglected for a while,

c) a library of standard exercisers for testing the HW up state, and

d) recommendations to the users on repair, replacement or suspension of failed HW from use;

(2) a portion of knowledge base on existing SW, that is at least:

a) data on kinds and functional capabilities of the existing standard SW means and identifiers assigned to each of such means,

b) data on the sources and kinds of SW failures and identifiers for specific SW means with decollation of identifiers for critical failures without recovery of which the restoration of the up state of computers 5 is impossible, and identifiers for failures which can be neglected for a while, and

c) software needed for diagnostics and recovery of the corrupted standard software up state on the computers 5, which includes a library of exercisers for testing SW, at least one program for restoration of the SW and at least one program for preferably automatic call to the Help Desk 1 from the computer 5 with indication of the identifier for corrupted software;

(3) database on computer viruses and software for their detection and elimination; and

(4) system for controlling said portions of knowledge bases and said database being capable of operating in automatic or interactive modes, as desired.

Such intermediate RES fragment can be used, as it is described above, for off-line repair servicing of computers 5 either

(1) immediately after detecting at least one failure of any of the computers 5 which the user cannot recover without assistance, or

(2) after preliminary use of the minimum-size RES fragment on RM 7.

It is apparent from the above description that when the restoration of the up state is achieved with the help of the intermediate RES fragment the repair servicing of the computer 5 is finished, and

if it is impossible to recover at least one failure, such computer 5 becomes connected to the Help Desk 1 via the communication channel 9, and

the repair servicing is continued with the help of the complete RES until the positive result is reached or up to the moment when it is observed that the RES needs to be upgraded.

It is also to be understood that in this case too only information on a combination of identifiers relating to the failure which has not been recovered with the help of the intermediate RES fragment is received at the Help Desk 1.

It is to be noted, that decollating intermediate RES fragments for off-line repair servicing of computers 5 is especially useful when groups of such computers 5 are connected in local networks, and it is as much more economically expedient as greater number of computers 5 is included in such group.

It is obvious that RES fragments stored on RM 7 or in SIRC 8 should be periodically upgraded with the help of a selected Help Desk 1 which has a complete regularly upgraded RES.

It should be noted at last that:

all the sources and kinds of actually possible failures can not be a priori foreseen at the moment of creation of a complete RES, and

the smaller is a decollated RES fragment, the fewer is the number of failures that can be diagnosed and recovered with the help of those fragments.

Therefore, so called “software stubs” are provided in the structure of the complete RES and generally included in the decollated fragments. They are intended to mark those hardware or software means of any specific computer 5 the failure of which have failed to be diagnosed and/or recovered with the help of a RES fragment or even the whole complete RES. The same “stubs” are found in all the unidentified hardware or software means which appear on the market after the beginning of operation of the complete RES or its decollated fragment.

The data on the involved stubs is recorded in the reports on repair servicing along the whole line “(RM 7)—SIRC 8—Help Desk 1” for the subsequent analysis and, if necessary, for upgrading the complete RES and refining its working fragments.

### INDUSTRIAL APPLICABILITY

The invention is industrially applicable because the method and system for repair servicing of computers by stepwise use of the RES:

first, can be performed on the basis of known resources of components, and

second, guarantee substantial reduction in traffic on communication channels and lowering specific expenses for hardware, software and other means for remote repair servicing in each individual case of call from a computer user for the external help in recovery of hardware and/or software failures.

1. A method for computer repair servicing, which—
first, is based on the use of repair expert system which comprises at least a database on hardware, a database on software, a database on the scripts of diagnostics and repair, and a system for controlling said databases including at least one means for connecting said repair expert system to a user's inoperative computer, and
second, comprises the steps of:
a) detecting at least one computer failure which its user cannot recover without assistance,
b) connecting the user's inoperative computer to said repair expert system,
c) at least once diagnosing hardware and software incorporated in the user's computer using said repair expert system, and detecting at least one hardware or software means whose corruption has caused a failure,
d) recovering the detected hardware failure or sending recommendations to the user on its recovery without assistance, and/or
e) recovering the detected software failure, and, if necessary,
f) possibly repeating steps (a), (b), (c), (d), (e) up to the positive result or suspension of the repair servicing
characterized in that
(1) a regularly upgraded repair expert system is created and used for computer repair servicing, which system generally comprises:
(1.1) a knowledge base on hardware existing by the date of the latest upgrade of said repair expert system, that is:
a) data on classes, types, design, functional capabilities and support drivers of hardware which are used in computers, and identifiers assigned to each known hardware,
b) data on producers of existing hardware, on the current availability of individual hardware on the market and on possibilities for equivalent replacement of failed hardware made by one producer with suitable hardware of the same type made by another producer, and identifiers assigned to the producers of existing hardware,
c) data on sources, kinds and assessments of hardware failures and identifiers for such assessments with decollation of identifiers for critical failures without recovery of which the restoration of the users' computers up state is impossible and identifiers for failures that can be neglected for a while,
d) a library of exercisers for testing hardware up state, which includes at least standard exercisers, and
e) recommendation to users on replacement, repair or suspension of failed hardware from use;
(1.2) a knowledge base on software existing by the date of the latest upgrade of said repair expert system, that is:
a) data on kinds and functional capabilities of at least existing standard software means and identifiers assigned to each of such means,
b) data on sources and kinds of software failures and identifiers for failures of specific software means with decollation of identifiers for critical failures without recovery of which the restoration of the users' computers up state is impossible, and identifiers for failures that can be neglected for a while, and
c) software needed for diagnostics and recovery of the corrupted software up state on the users' computers, which includes a library of exercisers for testing at least standard software, at least one program for restoration of such software and at least one program for preferably automatic call to a Help Desk from the user's computer with indication of the identifier for corrupted software;
(1.3) database on computer viruses and software for their recognition and elimination; and
(1.4) system for controlling said knowledge bases and said database being capable of operating in automatic or interactive modes, as desired;
(2) prior to application of the described repair expert system for computer repair servicing, at least one functionally isolated fragment is decollated therein, which fragment includes at least one program for preferably automatic call to a Help Desk from the user's computer when detecting at least one such hardware or software failure which can not be recovered under off-line repair servicing only with the use of said repair expert system fragment and without recovery of which the restoration of said computer up state is impossible, said program providing for transfer of only identifiers relating to each not-recovered failure to the Help Desk;
(3) said decollated repair expert system fragment is stored into a isolated storage-and-output device supplied to at least one such computer user who wants to subscribe for the services of the Help Desk; and
(4) after having detected at least one said failure, off-line repair servicing of the inoperative computer is carried out to the extent of the possibilities provided by said decollated fragment of the repair expert system, and then
(5) either such service is stopped when said computer up state has been restored or it is connected to the Help Desk via a communication channel and the repair servicing is continued with the help of this Help Desk which is equipped with the complete repair expert system.

2. A method according to claim 1 characterized in that the decollated fragment of the repair expert system includes at least:
a) data on classes, types, design, functional capabilities and support drivers of the hardware used in computers, and the identifiers assigned to each hardware device;
b) a library of standard exercisers for testing hardware up state;
c) recommendations to the users on repair, replacement or suspension of failed hardware from use;
d) data on kinds and functional capabilities of existing standard software means and identifiers assigned to each of such means;
e) identifiers for failures of specific standard software means with decollation of identifiers for critical failures without recovery of which the restoration of the users' computers up state is impossible, and identifiers for failures that can be neglected for a while; and
f) at least one exerciser for testing at least standard software;
g) at least one program for restoration of standard software; and
h) at least one program for preferably automatic call to the Help Desk from the user's computer when detecting at least one such hardware or software failure which can not be recovered under off-line repair servicing only with the use of said repair expert system fragment and without recovery of which the restoration of said computer up state is impossible, said program providing for transfer of only identifiers relating to each not-recovered failure to the Help Desk.

3. A method according to claim 1 characterized in that the decollated fragment of the repair expert system includes at least:
(1) a portion of a knowledge base on hardware, that is at least:
a) data on classes, types, design, functional capabilities and support drivers of hardware which are used in computers, and identifiers assigned to each hardware;
b) data on sources, kinds and assessments of hardware failures and identifiers for such assessments with decollation of identifiers for critical failures without recovery of which the restoration of the users' computers up state is impossible, and identifiers for failures that can be neglected for a while;
c) a library of standard exercisers for testing hardware up state; and
d) recommendations to users on repair, replacement or suspension of failed hardware from use;
(2) a portion of a knowledge base on the existing software, that is at least:
a) data on kinds and functional capabilities of existing standard software means and identifiers assigned to each of such means,
b) data on sources and kinds of software failures and identifiers for failures of specific software with decollation of identifiers for critical failures without recovery of which the restoration of the users' computers up state is impossible, and identifiers for failures that can be neglected for a while;
c) software needed for diagnostics and recovery of corrupted standard software up state on the users' computers, which includes a library of exercisers for testing software, at least one program for restoration of this software and at least one program for preferably automatic call to the Help Desk from the user's computer with indication of the identifier for the corrupted software,
(3) database on computer viruses and software for their recognition and elimination; and
(4) system for controlling said portions of knowledge bases and said database, which can operate in automatic or interactive modes, as desired;
(5) at least one program for preferably automatic call to a Help Desk from the user's computer when detecting at least one such hardware or software failure which can not be recovered under off-line repair servicing only with the use of said fragment of the repair expert system and without recovery of which the restoration of said computer up state is impossible, said program providing for transfer of only identifiers relating to each not-recovered failure to the Help Desk.

4. A method according to claim 1 characterized in that software stubs are included in the complete repair expert system and in at least one functionally isolated fragment decollated therefrom, which stubs are intended to mark hardware or software failures not specified by said system or the decollated fragment, such stubs being recorded in each report on diagnostics and repair of each inoperative computer for the subsequent analysis and recovery of failures.

5. A system for computer repair servicing which has a Help Desk, the Help Desk comprising:
at least one unit of non-volatile memory for a long-term storage of the complete repair expert system;
an executive unit electrically connected to said at least one unit of non-volatile memory and equipped with at least one means for connecting inoperative users' computers to the repair expert system, and
a unit for analysis and storage of the results of the repair servicing of users' computers, said unit being electrically connected to said at least one unit of non-volatile memory and said executive unit,
characterized in that
a) the system additionally comprises at least one isolated means for storage and output of information;
b) this means comprises a record of at least one fragment of the repair expert system adapted for off-line repair servicing of inoperative computers prior to calling to a Help Desk, and calling to the Help Desk only in case of detecting such failure that cannot be recovered with the help of said fragment;
c) this means is supplied to at least one such computer user who wishes to subscribe for services of the Help Desk.

6. A system according to claim 5 characterized in that said isolated means for storage and output of information is in the form of a preferably changeable repair medium.

7. A system according to claim 6 characterized in that said changeable repair medium is selected from the group consisting of a standard floppy disk, ZIP disk, CD-ROM disk, flash memory microcircuit and portable disk drive with a hard magnetic disk.

8. A system according to claim 5 characterized in that said isolated means for storage and output of information is in the form of a standalone intermediate repair computer which has at least one inherent unit of non-volatile long-term memory, inherent executive unit, inherent unit for the analysis and storage of the results of repair servicing of users' computers, which unit is electrically connected to at least one said unit of non-volatile memory and said executive unit, and an optional inherent means for connection to communication channels, said intermediate computer being located between the Help Desk and distant users' computers.

9. A system according to claim 8 characterized in that said repair computer is in the form of a minicomputer electrically connected to at least one user's computer.

10. A system according to claim 8 characterized in that said intermediate repair computer is in the form of an intermediate service computer located between the Help Desk and a group of users' computers situated in the same locality.
